(19) United States
(12) Patent Application Publication
(10) Pub. No.: US 2011/0296372 A1
(43) Pub. Date: Dec. 1, 2011

(54) DEPLOYMENT ENVIRONMENT SYSTEMS, METHODS, AND APPARATUSES FOR DEVELOPING APPLICATIONS AND DIAGNOSTIC PRICE AND/OR TIME QUOTE DETERMINATION SYSTEMS, METHODS, AND APPARATUSES FOR APPLICATION DEVELOPMENT SERVICES

(76) Inventors: Terrance Joseph Bird, Byron, MN (US); David Neville Brown, Pewsey (GB); Evan Charles Harter, III, New York, NY (US)

(21) Appl. No.: 13/040,654

(22) Filed: Mar. 4, 2011

Related U.S. Application Data
(63) Continuation-in-part of application No. 12/861,544, filed on Aug. 23, 2010.
(60) Provisional application No. 61/311,116, filed on Mar. 5, 2010.
(60) Provisional application No. 61/235,741, filed on Aug. 21, 2009.

(51) Int. Cl. G06F 9/44

(52) U.S. Cl. 717/102

(57) ABSTRACT

A server receives a request from a client to provide a price and/or time quote and transmits initial diagnostic questions. The server receives a response to the initial questions and generates a initial cost range and/or time range estimate quote based on weighting pre-assigned in a knowledge base to information included in the response. The weightings assigned to possible responses are based on analysis of historical data. The server transmits the initial cost and/or time estimate quote to the client. Further, the server may refine the initial cost range and/or time range estimate quote in response to a request. Refining may includes generating additional diagnostic questions, receiving a responses, generating a refined quote based on a weighting pre-associated in the knowledge base with information included in the responses, and transmitting the refined quote to the client. Refining the quote may be an iterative process.

### RELATED APPLICATIONS

The application claims priority under 35 U.S.C. §119(e) to U.S. Provisional Application Ser. No. 61/311,116, filed Mar. 5, 2010, which is herein incorporated by reference in its entirety.

This application is a continuation-in-part of U.S. application Ser. No. 12/861,544, filed on Aug. 20, 2010, which claims the benefit of priority under 35 U.S.C. §119(e) to U.S. Provisional Application Ser. No. 61/235,741, filed Aug. 21, 2009, which are herein incorporated by reference in their entireties.

### FIELD OF THE INVENTION

This invention relates generally to software applications, and more specifically to computing device deployment environments for developing applications. Implementations provide price and/or time quote determination, and more specifically to automated diagnostic price and/or time quote determination for services for developing applications using, for example, the deployment environments.

### BACKGROUND

Businesses, large and small, around the world struggle with delivering flexible solutions quickly enough to adapt business processes to new ways of doing business. Simultaneously, businesses struggle with reducing costs, providing better customer service, and enabling business expansion. However, creation and deployment of business applications is generally time consuming and technically challenging. Typically, business people are the knowledge workers. They are the source for information and requirements about how business applications need to work and the functions such applications need to serve.

Unfortunately, business people generally do not have the technical expertise to develop and deploy the business applications. Often, business people have to rely on information technology people for development and deployment functions. This integration of business people and technical people for developing and deploying business applications, typically necessary to bring together the source of information and requirements with the necessary technical ability, consumes time and adds complexity to the creation of business applications. Further, development and deployment are typically performed by technical people with differing skill sets. Integrating the efforts of these disparate technical people adds additional complexity. As businesses increasingly need situational applications (e.g., software applications developed quickly to meet a specific business need) the time and complexity required for development and deployment may be prohibitive. As such, business users may not get the benefit of applications that could increase productivity, reduce costs, or otherwise help the business.

Businesses also struggle with reducing costs, providing better customer service, and enabling the expansion of the business, but the creation of business software applications are typically time consuming and technically challenging. As such, businesses typically need to purchase development services in order to develop the business software applications they require. However, the process of interacting with developers to define requirements and specifications of the business software applications in order to determine costs and times for development is often laborious and time consuming, frequently necessitating lengthy meetings and brainstorming sessions. Many businesses procrastinate and continue doing business without the tools they require because they do not think they have time to interact with developers, or because they mistakenly imagine the cost and time required for development are more than they can afford.

### SUMMARY

The present disclosure discusses systems, methods, and computer program products for providing deployment environments for quickly and simply developing and deploying software applications without the need for advanced technical expertise. A deployment environment is executed on a computing device. Users may access the deployment environment utilizing a browser to communicate requests related to the development of one or more software applications to the deployment environment. The deployment environment, in response to such requests, may automatically create the software application based on the user's input. The deployment environment may then deploy the created software application in response to an indication from the user. The deployment environment may deploy the application by providing the user with an automatically created reference (such as a uniform resource locator link, an iframe uniform resource locator, and so on) to the created software application. When such a created software application is accessed via a browser utilizing such a reference, the deployment environment may execute the created software application and deliver access to the created software application by receiving input for the executing software application from the browser as well as providing output for the executing software application to the browser.

In some implementations, the deployment environment may allow the user to choose between using a software application creation wizard and a development tool for designing and developing the software application. The software application creation wizard may present a series of prompts that guide the user through a default template for designing a software application, which is then automatically created based at the user's responses. The development tool may include an interface (such as a graphical user interface) where the user can select pre-assembled application components to construct the software application. Further, the development tool may provide the user the ability to customize one or more of the pre-assembled application components by adding in their own programming code, modifying the programming code of the pre-assembled components, and so on. The development tool may receive and collect selections made by the user and the deployment environment may then automatically create the software application based the user's selections and/or modifications.

The present disclosure also provides systems, methods, and computer program products for automated diagnostic price and/or time quote determination, which may be used in connection with developing software applications using deployment environments provided herein. A deployment environment computing device may be configured as a server computing device, which may receive a request from a browser executed by a user computing device configured as a client computing device to provide a price and/or time quote, which may be a price and/or time quote for application development services. The deployment environment computing device may transmit an initial set of diagnostic questions, which may be retrieved from a knowledge base, to the user computing device. The knowledge base may include information concerning factors that influence the cost and/or time required to develop business software applications, statistical information about costs and/or times associated with developing business software applications, and other such information. The user computing device may display the initial set of diagnostic questions to a user (e.g., a potential client) via the browser application. The deployment environment computing device may receive a response to the initial set of diagnostic questions from the user computing device and the deployment environment computing device may generate an initial cost and/or time estimate quote based on weighting pre-assigned to information included in the response. The initial cost and/or time estimate quote may be a range of costs and/or times. The knowledge base may include weightings pre-assigned to possible responses that the user is allowed to select in response to the initial set of questions. The weightings assigned to possible responses included in the knowledge base may be based on analysis of historical data regarding development of previous business software applications. The deployment environment computing device may transmit the initial cost and/or time estimate quote to the user computing device which may display the initial cost and/or time estimate quote to the user via the browser application.

Further, the deployment environment computing device may refine the initial cost and/or time estimate quote in response to a request from the user computing device. Refining the initial cost and/or time estimate quote may includes generating at least one additional set of diagnostic questions from the knowledge base of information, receiving a response from a set of possible responses to the additional sets of diagnostic questions, generating a refined cost and/or time estimate quote based on a weighting pre-associated in the knowledge base with information included in the response, and transmitting the refined cost and/or time estimate quote to the client device. The refined cost and/or time estimate quote may be range of costs and/or times that is narrower than the initial cost and/or time estimate quote or may even be a fixed cost and/or time quote rather than an estimate range. The additional sets of diagnostic questions may include additional factors that influence the cost and/or time required to develop business software applications. The additional sets of diagnostic questions may include additional factors that are more detailed and/or technical that the initial set of diagnostic questions. Additionally, refining the initial cost and/or time estimate quote may be an iterative process. In this way, the user's interest may be maintained as they are able to refine based on the amount of additional interaction they are willing to expend. This increases the likelihood that the user will participate long enough to purchase development services.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for developing and deploying software applications, in accordance with one or more implementations of the present disclosure;

FIGS. 2A and 2B are a flow chart illustrating a method for developing and deploying software applications which may be performed by the system of FIG. 1;

FIG. 2C is a method diagram illustrating a method of price quote determination for application development services which may be performed by the system of FIG. 1; and

FIGS. 3A-3L illustrate example user interface screens that may be displayed by the browser application executing on the user (e.g., client) computing device in accordance with an example implementation of the present disclosure.

### DETAILED DESCRIPTION OF THE EMBODIMENTS

The description that follows includes systems, methods, techniques, instruction sequences, and/or computer program products that embody techniques for implementing the present disclosure. However, it is understood that the described disclosure may be practiced without these specific details. Reference will now be made in detail to the subject matter disclosed, which is illustrated in the accompanying drawings.

The present disclosure describes computing device environments for quickly and simply developing and deploying software applications. The complexities associated with developing and deploying business applications are addressed herein by providing deployment environments which may be utilized to create, develop, and deploy software applications. As the same environment creates, develops, deploys, and executes the software applications, the complexity of development and deployment is reduced. For example, a user who develops and deploys a software application does not require advanced programming skills as the user can utilize components which have already been programmed and created to perform the functionality the user desires. By way of an additional example, a user is freed from addressing whether or not a developed application will be compatible with the eventual deployment mechanism as the same environment that is utilized to develop the software application also deploys the application. By way of still another example, a user is not required to configure servers to deploy a developed software application as the deployment environment is already configured to deploy the software application upon the user's specification. Thus, software applications may be developed and deployed without the need for advanced technical expertise.

Further, the deployment environment may include graphical user interfaces that provide software application creation wizards and/or development and deployment tools that include selectable pre-built application components corresponding to commonly utilized functionalities. By providing software application creation wizards that include a series of prompts for guiding users through default templates for development and deployment of software applications, even completely non-technical users may be able to develop and deploy software applications. Additionally, the ability to utilize development and deployment tools to graphically select pre-assembled application components may allow users with slightly more technical skill to incorporate various functionalities into software applications without having the increasingly advanced skills necessary to develop components to provide such functionalities. Moreover, such pre-assembled application components may be customized, allowing less technical users to develop and deploy the majority software applications while still enabling implementation of further advanced functionality through individual customization of pre-assembled component by technical personnel.

Moreover, the deployment environment may be utilized by multiple parties, such as a software developer and a client purchasing services from the software developer. In this example, the deployment environment is programmed to provide automated diagnostic price and/or time quote determination for application development services provided to the client by the software developer utilizing the deployment environment to render the services. While this allows the software developer to develop and deploy the software application utilizing the deployment environment, it also allows the client to collaborate with the software developer in the development and deployment process, for example, by providing the client with access to the deployment environment.

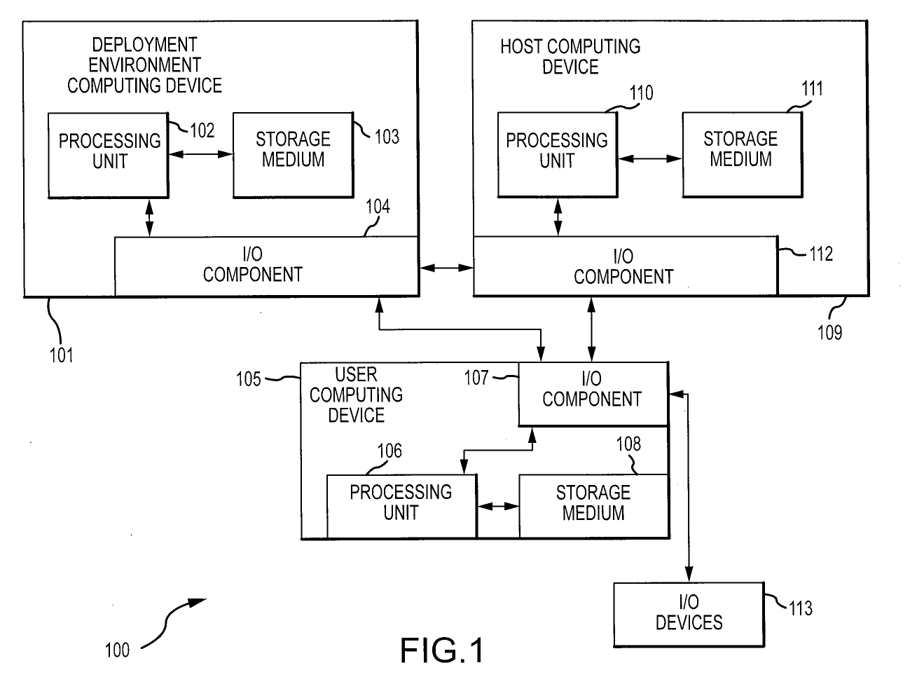

FIG. 1 is a block diagram illustrating a system 100 for developing and deploying software applications, in accordance with one or more implementations of the present disclosure. The system includes a deployment environment computing device 101 communicably connected (such as via a network connection) to a user computing device 102. The deployment environment computing device may provide the deployment environment of the present disclosure. The user computing device may be utilizable by one or more users to access the deployment environment and/or one or more software applications deployed by the deployment environment via the input/output component. The deployment environment computing device and the user computing device may each be any kind of computing device such as a server computing device, a desktop computing device, a laptop computing device, and so on. Further, although the deployment environment computing device and the user computing device are illustrated and described as single computing devices, in some implementations they may include multiple computing devices, such as computing devices arranged in a cloud configuration. Moreover, although they are illustrated and described as separate devices, in some implementations they may be incorporated into the same device.

The deployment environment computing device 101 includes one or more processing units 102, a tangible storage medium 103 (which may include any kind of non-transitory storage medium), and one or more input/output components 104 which may be coupled by one or more buses. The processing unit of the deployment environment computing device may execute instructions stored in the tangible medium to implement the deployment environment of the present disclosure. Additionally, the processing unit may execute instructions stored in the tangible medium to implement a browser (such as a web browser) that may one or more users may use to access the deployment environment and/or one or more software applications deployed by the deployment environment.

Similarly, the user computing device 105 includes one or more processing units 106, a tangible storage medium 108 (which may include any kind of non-transitory storage medium), and one or more input/output components 107, which may be coupled by one or more buses. The user computing device may also include one or more input/output devices 113, such as monitors, keyboards, mice, and so on, coupled to the input/output component 107. The processing unit of the user computing device may execute instructions stored in the tangible medium to implement a browser (which may be a web browser such as a Internet Explorer™ web browser, a Netscape™ web browser, a Mozilla™ web browser, a Firefox™ web browser, a Safari™ web browser, and so on) that one or more users may use to access the deployment environment and/or one or more software applications deployed by the deployment environment via the input/output component.

The deployment environment computing device 101 may execute a deployment environment. One or more users may access the deployment environment (via the input/output component 107 and the input/output component 104) utilizing a browser executing on the user computing device 105. The user may transmit input to the deployment environment and receive output from the deployment environment via the browser. In this way, the user may communicate requests related to the development of one or more software applications to the deployment environment. The deployment environment, in response to such requests, may automatically create the software application based at least one the user's input. Further, the deployment environment may deploy the created software application in response to an indication from the user that the created software application should be deployed.

The deployment environment may deploy the application by providing the user with an automatically created reference to the created software application (such as a uniform resource locator link, an iframe uniform resource locator, and so on) that can be utilized to access and execute the created software application within the deployment environment. For example, the deployment environment may provide access to applications via a world wide web address “www dot server dot com/deploymentevironment/”. As such, when the deployment environment creates a software application titled “addressbook”, the deployment environment may automatically generate a uniform resource locator of “www dot server dot com/deploymentevironment/addressbook.html” that may be utilized to access the created addressbook software application and provide the automatically generated link to the user. The user (and/or other users) may then access the created software application utilizing the reference via the browser of the user computing device 105 (and/or other user computing devices). When such a created software application is accessed utilizing such a reference, the deployment environment may execute the created software application and deliver access to the created software application by receiving input for the executing software application from the browser as well as providing output for the executing software application to the browser.

Subsequent to deployment of the created software application, one or more users may submit one or more requests to the deployment environment to modify the created software application. In response to receiving such requests, the deployment environment may be operable to modify the created software application such that future accesses to the created software application access the modified software application. The deployment environment may be operable to so modify the created software application without requiring redeployment.

Additionally, in some implementations the system 100 may also include a host computing device 109, which may be any kind of computing device and may include one or more processing units 110, a tangible storage medium 111, and one or more input/output components 112. The host computing device may be communicably coupled to the deployment environment computing device 101 and the user computing device 105 via one or more communication networks (such as a local area network or the Internet) and the processing unit of the host computing device may execute instructions stored in the tangible medium to implement a network host service to provide users with access to network resources (such as web pages or applications) over the communication network.

The network host service may be configured to access the reference (such as via a uniform resource locator link and/or an iframe uniform resource locator included in one or more web pages) in response to one or more requests received via a browser executing on a user computing device, such as the user computing device 105. Although the host computing device and the deployment environment computing device are shown and described as separate devices, in various implementations they may be incorporated into the same device.

To aid the user in communicating requests related to the development of a software application, the deployment environment may provide one or more software application creation wizards to the user. Such a wizard may present a series of prompts (such as a series of screens upon which the user can select various option) that guide the user through a default template for designing a software application. Such a default template may be based on frameworks of commonly utilized applications, such as the ability to enter data, store the entered data, modify the entered data, and view the entered data. The wizard may receive and collect responses that the user makes to the series of prompts and the deployment environment may then automatically create the software application based at least on the responses. The deployment environment may include modules which have been preprogrammed to perform various functions which the development environment may automatically link and customize based on the user's responses. For example, based on the above framework, the deployment environment may include database modules, screen modules for data entry and presentation, and interaction modules that enable interaction between the database modules and the data entry and presentation screen modules. Based on the user responses to the prompts, the deployment environment may automatically create the software application by creating or modifying one or more tables implemented in the database modules, creating or modifying one or more of the data entry and presentation screens implemented by the screen modules, configuring how the interaction modules enable interaction between the tables implemented in the database modules and the data entry and presentation screens, and so on. After the deployment environment creates the application, the deployment tool may allow the user to deploy the application by selecting a single selection element, such as graphically checking a deploy check box.

Additionally, the deployment environment may provide one or more development tools to the user to aid that user in communicating requests related to the development of a software application. Such a development tool may include an interface (such as a graphical user interface) where the user can select pre-assembled application components to construct the software application. The pre-assembled components may be pre-programmed modules which perform different functionalities that may be utilized in a software application. The functionality that may be performed by a software application may be limited to the functionality which modules corresponding to pre-assembled components provided by the development environment have been pre-programmed to perform. The development tool may receive and collect selections made by the user and the deployment environment may then automatically create the software application based at least on the selections by modifying and linking the various modules corresponding to the selected pre-assembled application components as specified by the user.

Further, the development tool may provide the user the ability to customize one or more of the pre-assembled application components by adding in their own programming code, modifying the programming code of the pre-assembled components, and so on. To provide the user the ability to customize pre-assembled components and so on, the development tool may provide compilers or interpreters as well as information regarding how to integrate user programming code with the pre-defined components (such as application programming interfaces specifying data of the pre-defined components, how to interact with that data, and so on). The development tool may also provide the user with the ability to add and utilize interfaces (such as application programming interfaces) to other applications whether inside or outside of the deployment environment (such as Google™ Apps). If the user utilizes the development tool to customize the one or more pre-assembled application components, the deployment environment may include the customizations (including any programming code received from the user) when creating the software application. When including customizations, the deployment environment may utilize one or more compilers, interpreters, linkers, and so on to verify that the user programming code is syntactically correct, correctly accesses data of other modules corresponding to selected pre-assembled application components, and so on. If the deployment environment cannot verify the user programming code, the deployment environment may provide one or more error messages to the user regarding the failed verification. After the deployment environment creates the application, the deployment tool may allow the user to deploy the application by selecting a single selection element, such as graphically checking a deploy check box.

In various implementations, the deployment environment may present a user with a choice as to whether to use a software application creation wizard or a development tool when the user selects to create a software application. However, in various other implementations the deployment environment may default to either a software application creation wizard or a development tool or only one of the two may be made available to the user.

In further implementations, the deployment environment may provide for automated diagnostic price and/or time quote determination for application development services provided using the deployment environment. For example, where a developer manages the deployment environment and provides development services to clients, the deployment environment may receive inputs from clients interested in having a software application created for them, and the deployment environment provides diagnostic price and/or time quote for software to be developed using the deployment environment.

According to this implementation, the user computing device 105 may be configured as a client computing device and may implement a browser application, such as a web browser, by utilizing the processing unit 106 to execute instructions stored in the storage medium 108. The user computing device 105 may be operable to receive input from a user for the browser application from one or more input devices (not shown); such as a keyboard, mouse, touchpad, track pad, trackball, numeric keypad, and so on; via the input/output component 107. The user computing device 105 may also be operable to display output concerning the browser application on one or more output devices (not shown); such as a cathode-ray tube display, a liquid crystal display, a plasma screen display, a speaker, a printer, and so on; via the input/output component 107.

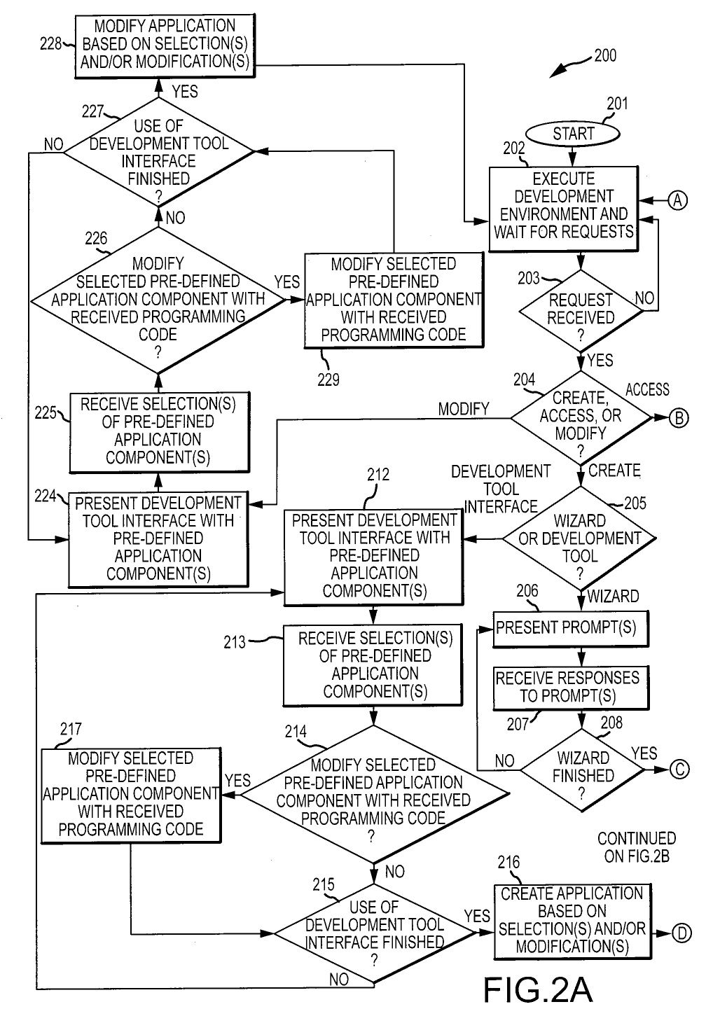

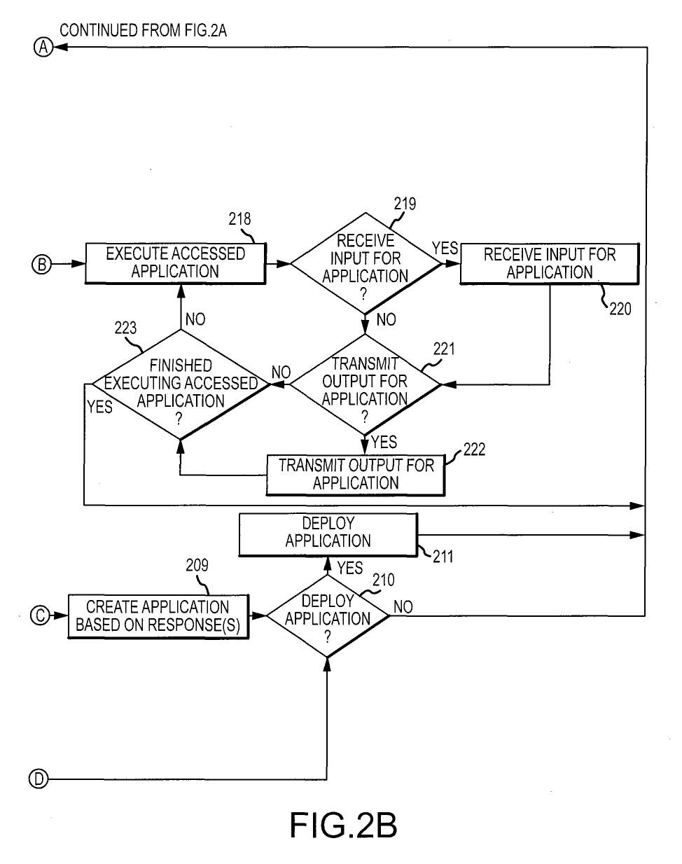

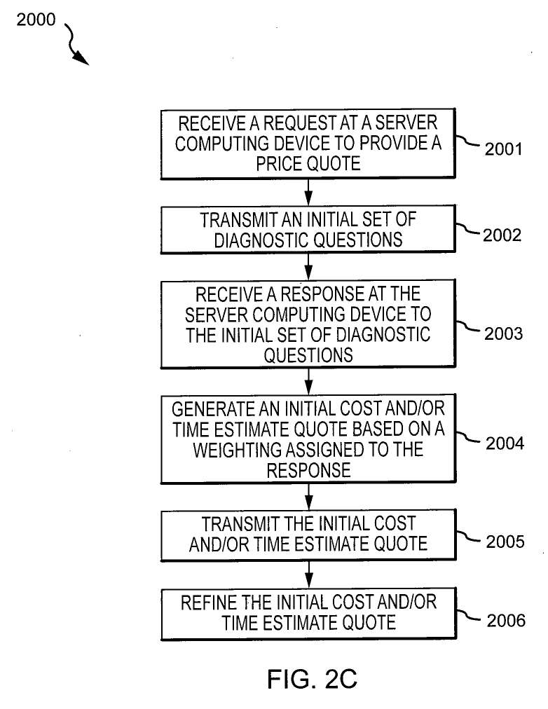

FIGS. 2A and 2B are a flow chart illustrating a method 200 for developing and deploying software applications. The method 200 may be performed by the system 100 of FIG. 1. The flow starts at block 201 and proceeds to block 202. At block 202, the deployment environment computing device 101 executes the deployment environment and waits for requests. The flow then proceeds to block 203 where the deployment environment determines whether a request has been received. If a request has been received, the flow proceeds to block 204. Otherwise, the flow returns to block 202 to wait for requests to be received. At block 204, the deployment environment determines whether the received request is a request to create a software application, a request to access a software application, or a request to modify a software application. If the request is to create a software application, the flow proceeds to block 205. If the request is to access a software application, the flow proceeds to block 218. If the request is to modify a software application, the flow proceeds to block 224.

At block 205, after a request to create a software application has been received, the deployment environment determines whether to utilize a wizard or a development tool to create the software application. If the deployment environment will use a wizard to create the software application, the flow proceeds to block 206. Otherwise, the flow proceeds to block 212.

At block 206, after determining to utilize a wizard to create the software application, the deployment environment presents one or more prompts related to the wizard and the flow proceeds to block 207. At block 207, the deployment environment receives responses to the prompts. The flow then proceeds to block 208 where the deployment environment determines whether the wizard is finished. If the wizard is not finished, the flow returns to block 206. Otherwise, the flow proceeds to block 209.

At block 209, the deployment environment automatically creates the software application at least based on the responses to the prompts. The flow then proceeds to block 210 where the deployment environment determines whether to deploy the created software application. At block 210, if the created software application is to be deployed, the flow proceeds to block 211 where the deployment environment deploys the created software application. The flow then returns to block 202 where the deployment environment waits for additional requests to be received. However, if the created software application is not to be deployed, the flow returns from block 210 to block 202 where the deployment environment waits for additional requests to be received.

At block 212, after determining to utilize a development tool to create the software application, the deployment environment presents a development tool interface that includes selectable pre-defined application components and the flow proceeds to block 213. At block 213, the deployment environment receives selections of the pre-defined application components. The flow then proceeds to block 214 where the deployment environment determines whether to modify any of the selected pre-defined application components with programming code received from a user. If so, the flow proceeds to block 217 where the deployment environment modifies the selected pre-defined application components with the received programming code before proceeding to block 215. If not, the flow proceeds from block 214 to block 215. At block 215, the deployment environment determines whether the development tool is finished. If the development tool is not finished, the flow returns to block 212. Otherwise, the flow proceeds to block 216. At block 216, the deployment environment automatically creates the software application at least based on the selections and/or modifications. The flow then proceeds to block 210 where the deployment environment determines whether to deploy the created software application.

At block 218, after the deployment environment receives a request to access a software application, the deployment environment executes the accessed software application and the flow proceeds to block 219. At block 219 the deployment environment determines whether there is input to receive for the accessed software application. If so, the flow proceeds to block 220 where the input is received before the flow proceeds to block 221. If not, the flow proceeds to block 221 where the deployment environment determines whether there is output to transmit for the accessed software application. If so, the flow proceeds to block 222 where the output is transmitted before the flow proceeds to block 223. If not, the flow proceeds to block 223 where the deployment environment determines whether execution of the accessed software application is finished. If so, the flow returns to block 202 where the deployment environment waits for additional requests to be received. If not, the flow returns to block 218 and continues to execute the accessed software application.

At block 224, after the deployment environment receives a request to modify a software application, the deployment environment presents a development tool interface that includes selectable pre-defined application components and the flow proceeds to block 225. At block 225, the deployment environment receives selections of the pre-defined application components. The flow then proceeds to block 226 where the deployment environment determines whether to modify any of the selected pre-defined application components with programming code received from a user. If so, the flow proceeds to block 229 where the deployment environment modifies the selected pre-defined application components with the received programming code before proceeding to block 227. If not, the flow proceeds from block 226 to block 227.

At block 227, the deployment environment determines whether the development tool is finished. If the development tool is not finished, the flow returns to block 224. Otherwise, the flow proceeds to block 228. At block 228, the deployment environment modifies the software application at least based on the selections and/or modifications. The flow then returns to block 202 where the deployment environment waits for additional requests to be received.

The software application creation wizard that may be provided by the deployment environment will now be discussed in detail. In one example, the software application creation wizard may assume a default template that most software applications require three basic view: a data entry view, a data access view, and an administration view. For creating software applications that include these three views, the deployment environment may include database modules, screen modules for data entry and presentation, and interaction modules that enable interaction between the database modules and the data entry and presentation screen modules. The software application creation wizard may guide a user through creation of a software application that includes these three views.

The software application creation wizard may provide a first screen where users can enter each item of information that they wish to collect as well, the data type of that information, the method by which to collect that information (radio buttons, drop down menus, text boxes, and so on), and whether that information is mandatory. A user may be able to add the specified information item by selecting a button indicating to add that information item. The software application creation wizard may then provide a second screen where a user can specify different security options, such as who can enter data, view data, and administer data. The software application creation wizard may also present a confirmation screen where the user can verify that their responses thus far have been correct. If the user confirms, the wizard may present a arrangement screen that illustrates a default arrangement of data entry elements for the information items specified by the user. The user may be able to drag and drop the data entry elements to rearrange them on the arrangement screen.

The user may then be able to select to end the software application creation wizard, automatically creating the software application based on the provided responses and deploying the created software application. In automatically creating the software application, the deployment environment may create or modify one or more tables implemented in the database modules based on the responses, create or modify one or more of the data entry and presentation screens implemented by the screen modules based on the user responses, configure how the interaction modules enable interaction between the tables implemented in the database modules and the data entry and presentation screens based on the responses, and so on.

For example, a user may utilize the above software application wizard to create an address book application. On the first screen the user may specify that they wish to collect a name, a phone number, and an email address. The user may specify on the first screen that the name is a text value, the phone number is a number value, and the email address is an email. On the second screen the user may specify that anyone who accesses the application is allowed to enter data, view data, and/or administer data. On the arrangement screen the user may be presented with a default arrangement of a name box, phone number box, an email address box, and a button to submit entered data. The user may drag and drop to rearrange and/or resize the boxes on the screen from the default arrangement. Then, the user may select to end the software application wizard. In response, the associated development environment may automatically create the address book application by creating tables implemented in database modules corresponding to the text boxes, create appropriate a data entry/data presentation/data administration screens from the rearranged arrangement screen, and configure how the interaction modules enable interaction between the created tables and presentation screens.

It should be understood that the above described software application creation wizard is for the purposes of example only. Such a software application creation wizard may include any variety of numbers of prompts which may each prompt for a variety of responses.

The development tool that may be provided by the deployment environment will now be discussed in detail. The development tool may include a graphical interface, which may be a WYSIWYG (what you see is what you get) editor that provides a plurality of controls (such as buttons, drag and drop elements, menu bars, etc.) that a user can utilize to create and customize one or more screens for a software application. For example, the controls may be utilizable by the user to add or customize elements of a software application the user is creating or modifying. These elements include, but are not limited to, text (inputting and/or formatting), graphical elements (inserting and/or modifying), browser based form controls (fields, buttons, etc.), HTML (hypertext markup language) layout controls (frames, iFrames, in-line positioning, etc.), JavaScript functions and routines, cascading styles sheets, dynamic HTML, database tables and appropriate mapping, multiple or single screens, calls and links to programs and data sources external to the deployment environment (application programming interfaces, web services, etc.), and/or pre-defined functional elements (such as database views and interface objects). The interface objects included in the pre-defined functional elements that the user may add or customize for their software application may be components of software modules pre-developed to provide commonly utilized functionality for software applications. These commonly utilized functionalities may include, but are not limited to views of database tables, customer information, order management, quotation production, product information, shopping cart functionality, and/or help desk/product returns. The user may be limited to functionalities for which modules have been pre-programmed unless they develop additional modules to provide additional functionality. However, by utilizing pre-built components that provide commonly utilized functionality, a user is able to incorporate these functionalities into their software application without having to construct components to provide such functionalities.

The controls may allow a user to create one or more database tables that are stored within the deployment environment (and may be accessible by other applications developed within the deployment environment) and map those database tables to elements of the software application the user is creating or modifying. The controls may also allow a user to link the user's software application to other software applications existing within the deployment environment. Thus, in creating or modifying an application, a user may include any or all of the following: text (stylized, bolded, italicized, color, etc.), HTML form objects (text fields, radio buttons, combo boxes, check boxes, text areas, etc.), HTML positioning elements (in-line, tables, etc.), CSS (for object style, positioning, and etc.), Javascript, one or more database tables stored within the deployment environment, links to database tables external to the deployment environment, fields linked to either or both of the internal and external database tables, views (single table or joined) linked to either or both of the internal and external tables, and/or calls to other programs (application programming interfaces, web services, command line calls, etc.).

The development tool may also include one or more compilers, interpreters, specification documents, and so on. These provided compilers, interpreters, may enable the user to customize one or more of the pre-assembled application components by adding in their own programming code, modifying the programming code of the pre-assembled components, and so on. The specification documents may describe how to integrate user programming code with the pre-defined components. For example, the specification documents may list and describe application programming interfaces which specify data utilized by the pre-defined components, appropriate methods of interacting with that data, and so on. When the deployment environment automatically creates the software application, the deployment environment may modify and link the various modules corresponding to the selected pre-assembled application components and any user created or modified components as specified by the user. When including user created or customized components, the deployment environment may utilize one or more compilers, interpreters, linkers, and so on to verify and build the components. If the deployment environment cannot verify the user created or modified component, the deployment environment may provide one or more error messages to the user regarding the failed verification.

By utilizing the controls included in the graphical interface, a business user may be able to develop applications without having technical programming ability. However, a business user may cooperate with one or more technical users to add or modify the software application to include enhanced functionality utilizing programming related aspects such as JavaScript and/or calls to other programs. In this situation, a business user may be able to develop the majority of the application without requiring assistance from technical users and may utilize the assistance of the technical user on the aspects including the enhanced functionality that requires programming ability.

After a user has created or modified a software application, the deployment environment is operable to receive an indication from the user to deploy the created software application. The indication from the user to deploy the created software application may constitute an action such as the user clicking a button or radio button operable to execute instructions to deploy the created software application. Thus, a business user may also deploy a created software application in addition to being able to create and modify a software application without requiring programming knowledge.

After the deployment environment has received an indication from a user to deploy the software application, the deployment environment may provide access to the created software application upon receiving a request that utilizes the provided reference. The deployment environment may require accessing users to authenticate themselves before the deployment environment will provide access to the software application. In addition, the deployment environment may require authentication if the created software application was configured to require authentication by the user who created it. If authentication is required, the deployment environment may provide multiple levels of permissions such that different users may be granted access to certain aspects of the created software application and denied access to others. For example, some users may be granted the ability to only access the application to enter data whereas other users may be granted the ability to access and read data. Further, still other users may be granted the ability to access and read data and administer the created software application.

Once deployed, the deployment environment may provide an automatically generated application network address that may be utilized to access the created software application. Such an automatically generated application network address may be a combination of a network address of the computing device that the deployment environment executes upon, an identifier that identifies the deployment environment to the computing device, and an identifier that identifies the created software application to the deployment environment. For example, the automatically generated application network address may be an internet protocol (IP) address that includes the IP address of the computing device that the deployment environment executes upon, a port number associated with the deployment environment, and a name of the created software application. A user may then make the automatically generated application network address available to other users by sending it to them directly, or incorporating it into a network resource (such as a link or an iFrame in a web page).

Alternatively, the deployment environment may provide access to various software applications that have been created and stored within the deployment environment. For example, the deployment environment may provide a list of available created software applications to authorized users who have connected to the deployment environment and the users may access the available created software applications by selecting them from the provided list. Thus, various users may utilize the deployment environment to access the application.

Moreover, the deployment environment may provide access for creating, modifying, and accessing software applications as a pay service. The deployment environment may refuse access by a user if that user has not paid a fee. Alternatively, the deployment environment may provide a portion of possible functionality to a user who has not paid a fee and may only provide the remaining possible functionality upon payment by that user. For example, an unpaid user may be able to access the deployment environment to create a software application, but may not be able to deploy the created software application until that user has paid the fee. In other examples, the unpaid user may be able to create and deploy software applications, but may not be able to utilize advanced features such as granular security, particular development tools, unlimited storage space for created software applications, unlimited simultaneous access to created software applications, and so on.

As software applications are designed and developed using the same computing device and deployment environment that is used to deploy them, development and deployment may be compatible. Thus, the deployment environment may be utilized to drive both the interface for creating and/or modifying applications as well as deployment of the finished software application. The deployment environment may serve both the interface and the deployed software application to users' browsers, which may provide uniformity and commonality between the development and deployment sides. As the software application is being designed and developed, respective HTML, associated files, databases, and folder structure required by the deployment environment for deployment may be created and organized in the deployment environment. Therefore, when a user is ready to deploy the created software application, the components required may be available. This may include unique application network addresses to allow embedding of the created software application in other hosted services (such as web sites) as well as direct access to the created software application through the deployment environment.

Additionally, the deployment environment may include a rules engine that stores and checks one or more rules. When a created software application stored within the deployment environment is accessed, the rules engine may check to see if the access corresponds to one or more rules. If the access corresponds to one or more rules, the deployment environment may perform one or more actions. For example, the deployment environment may set or clear a flag in a database, send an alert (such as an email), alter data in a database, call another application stored in the deployment environment, or perform other types of actions. The one or more rules may have been created by the user(s) who(m) created one or more software applications stored in the deployment environment.

By way of example, a user may have created a software application where other users can register for an electronic newsletter by entering their names into data field. The user may have created this newsletter specifically to capture the attention of another user named “Frank Lloyd” and may want to be alerted if Frank Lloyd utilizes the software application to register for the newsletter. When the user created the registration software application, the user may have created a rule that specified that they be emailed if anyone entered the name “Frank Lloyd” into that specific data field. The deployment environment may then check this rule when an access occurs and if the access is the entry of “Frank Lloyd” into that specific data field, the deployment environment may send an email notifying the specified user of that occurrence.

Returning to the system 100 of FIG. 1, according to certain implementations, the deployment environment computing device 101 may be configured, for example, to implement a dynamic price quoting and timing application for providing price quotes and times for building software applications utilizing the deployment environment described above. Such an implementation may be useful where a software developer utilizes the deployment environment computing device 101 for providing services to a purchasing client. The deployment environment computing device 101 utilizes the processing unit 102 to execute instructions stored in the tangible storage media 103 related to diagnostic price and time quoting. The quoting application may be executable by the deployment environment computing device 101 to receive requests and/or responses from a user (e.g., a potential client) submitted via the user computing device 105 by way of the browser application, and perform various processing to generate and transmit display information to be displayed via the browser application, and so on.

In this implementation, the tangible storage media 103 may store a knowledge base with information specifically tailored to the costs and/or times associated with developing business software applications utilizing the particular software application development environment, such as the deployment environment computing device 101 described above. Additionally, as part of diagnostic price and/or time quote determination, the deployment environment computing device 101 or another linked computing device may create and update a development environment in the software application development environment based on the user's responses to the diagnostic questions, thus saving time by having the development environment already customized for the user if the user decided to purchase the offered development services.

It will be understood that in the present implementation, although the deployment environment computing device 101 may be utilized by a software developer, the one or more user computing devices 105 may also be utilized by a software developer in connection with the deployment environment computing device 101. In such arrangements, multiple user computing devices 105 may be provided (e.g., computing devices arranged in a cloud configuration), where certain user computing devices 105 are configured for receiving input from a client desiring development services, while others are configured for receiving input from software developers providing these services by utilizing the deployment environment. It will also be appreciated that both the client and the software developer may collaborate in developing and deploying software utilizing the deployment environment computing device 101.

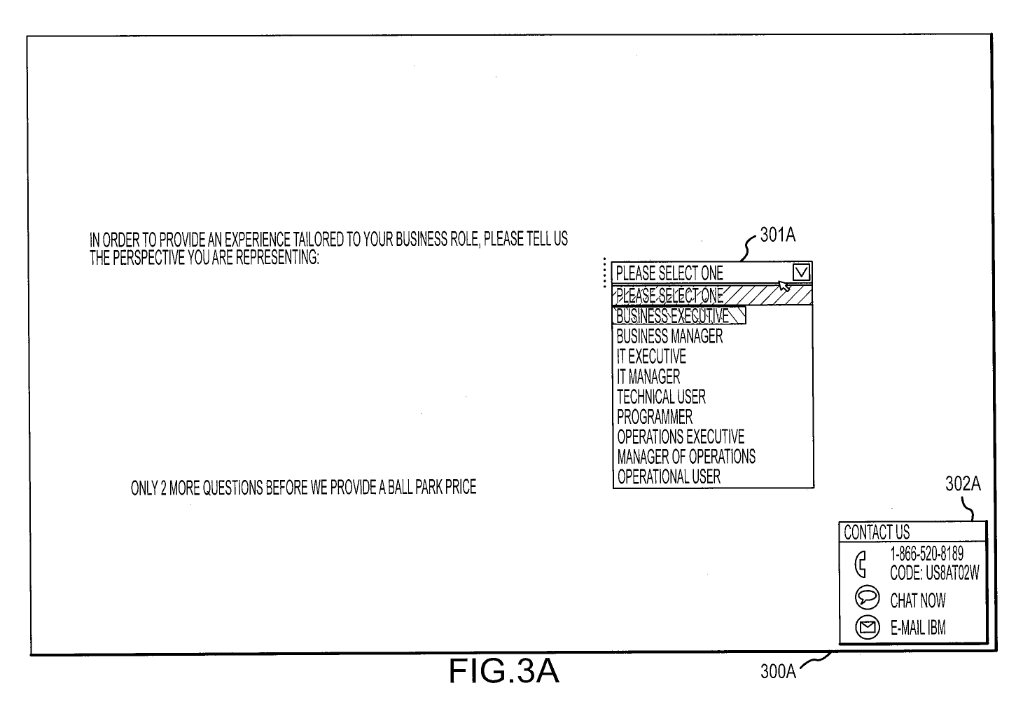

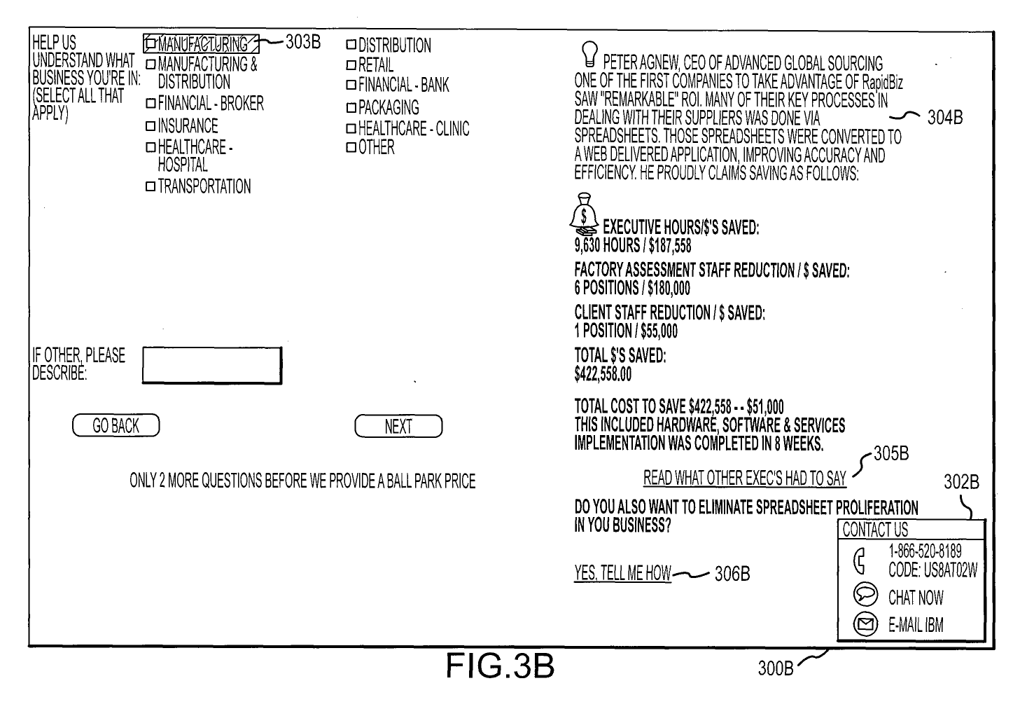

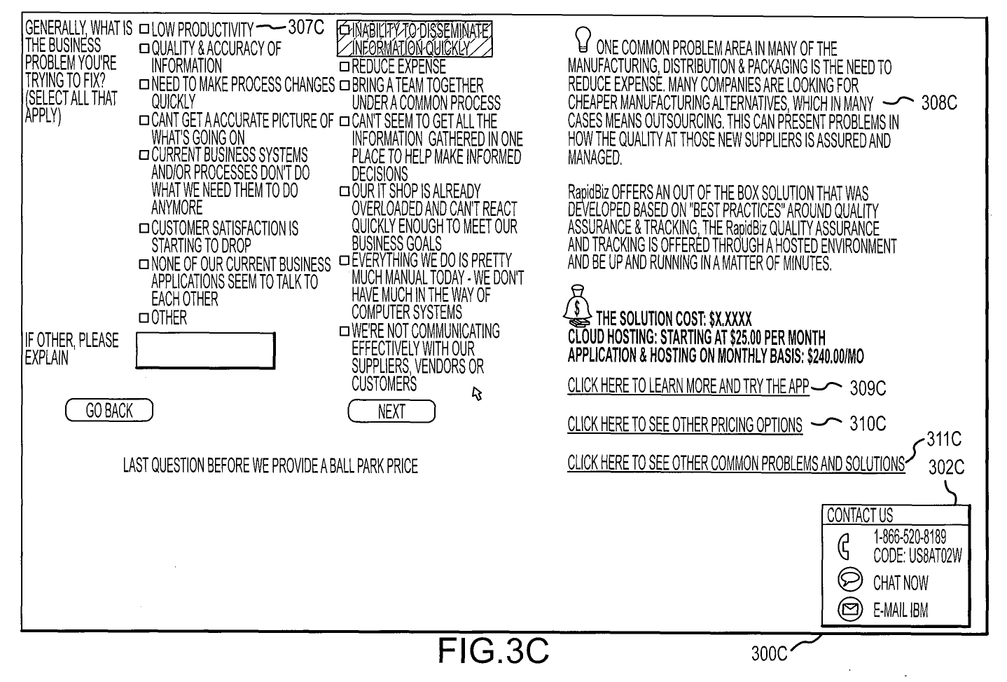

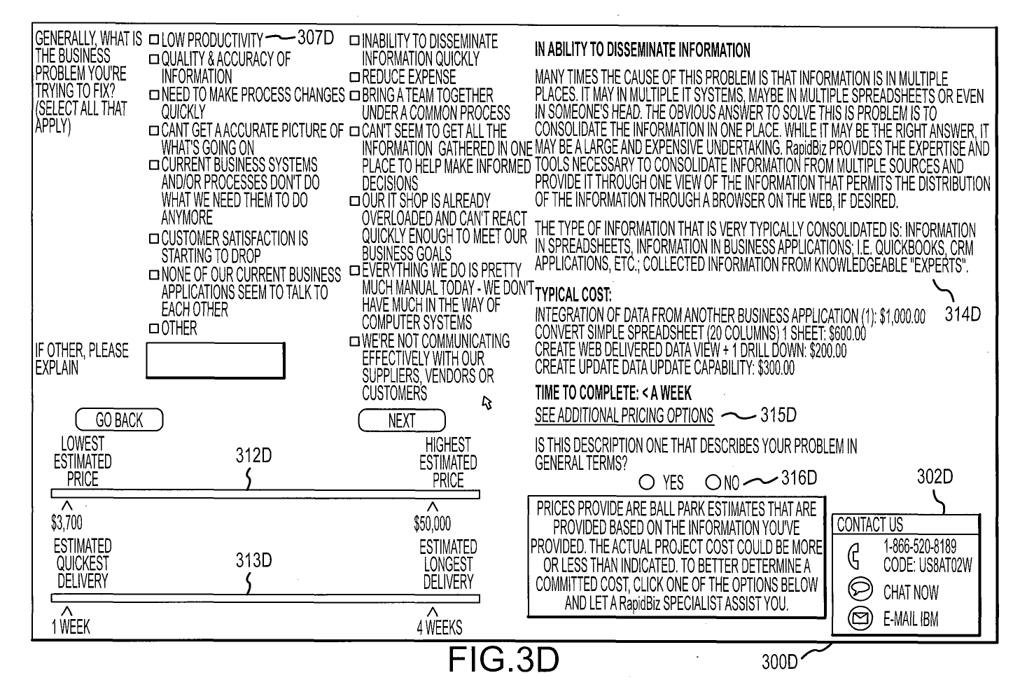

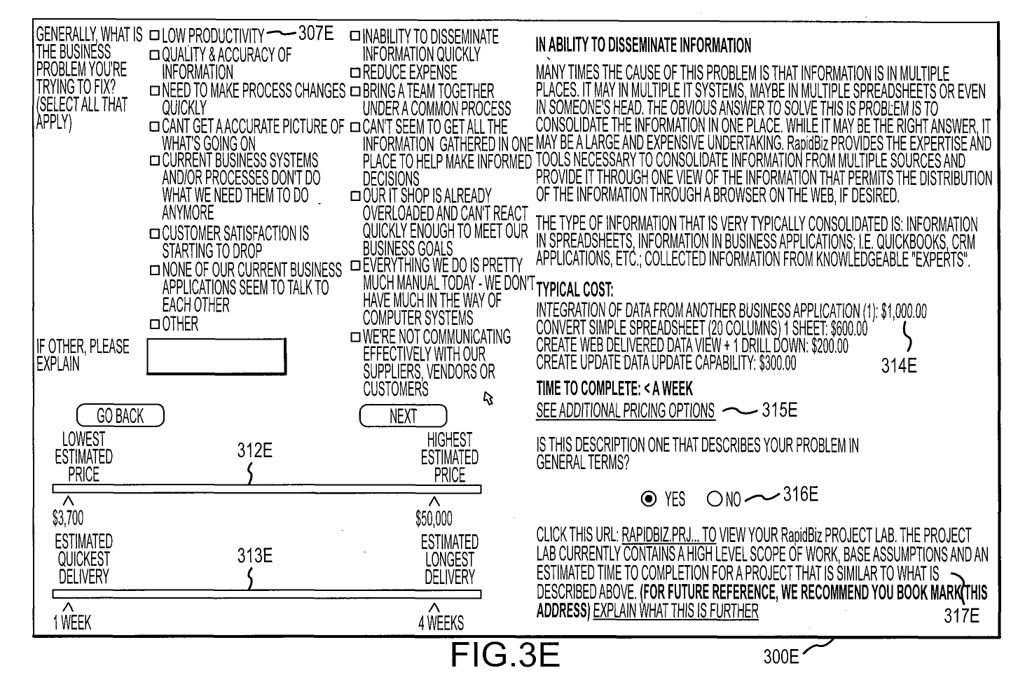

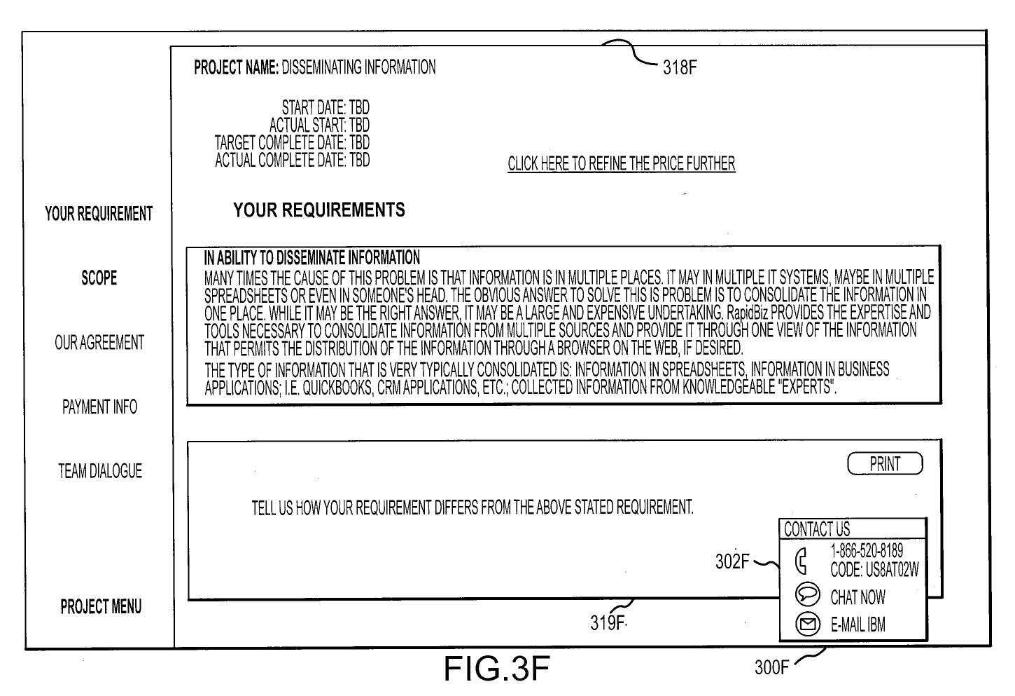

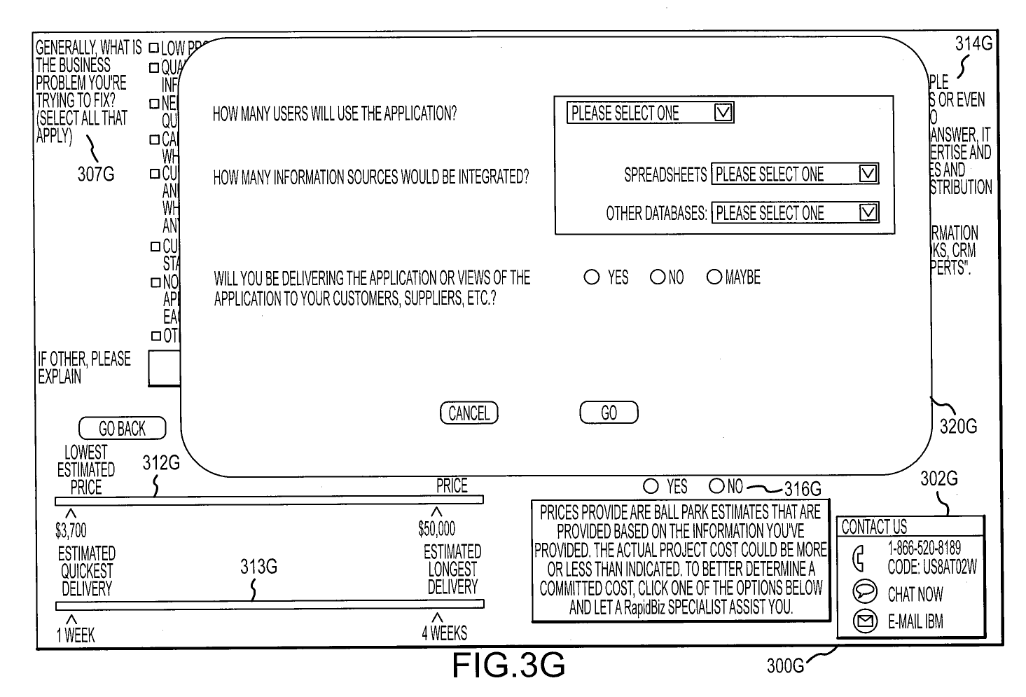

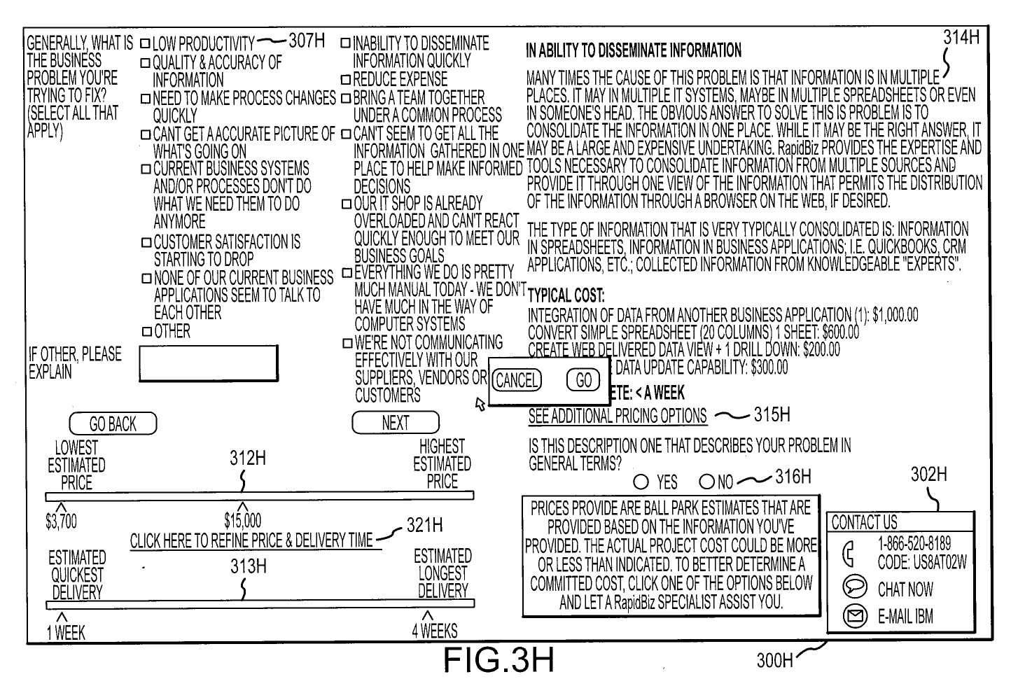

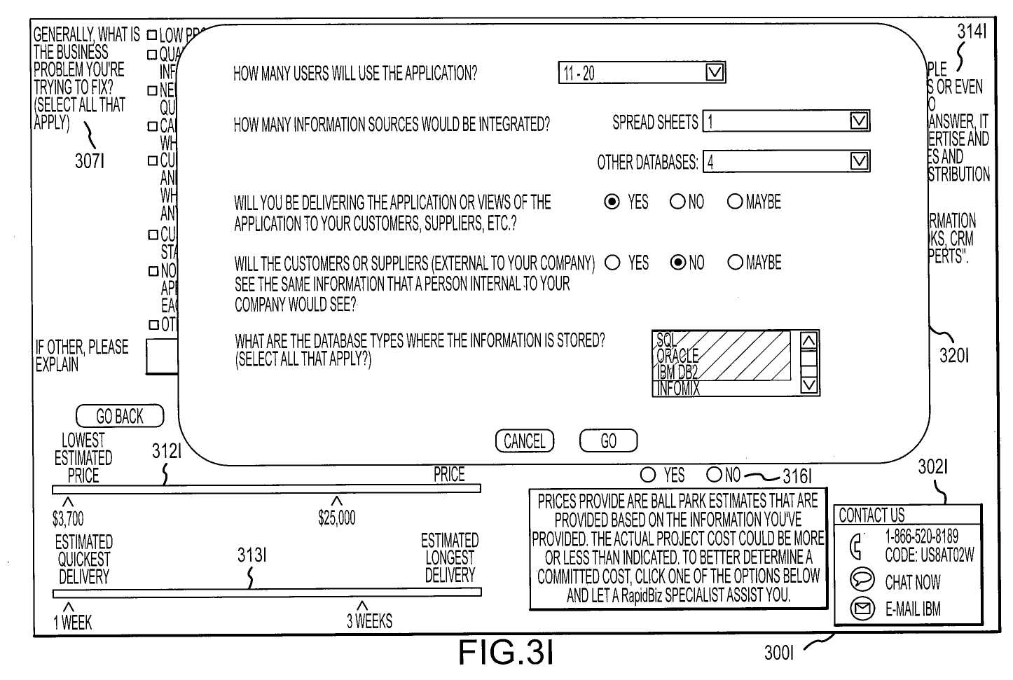

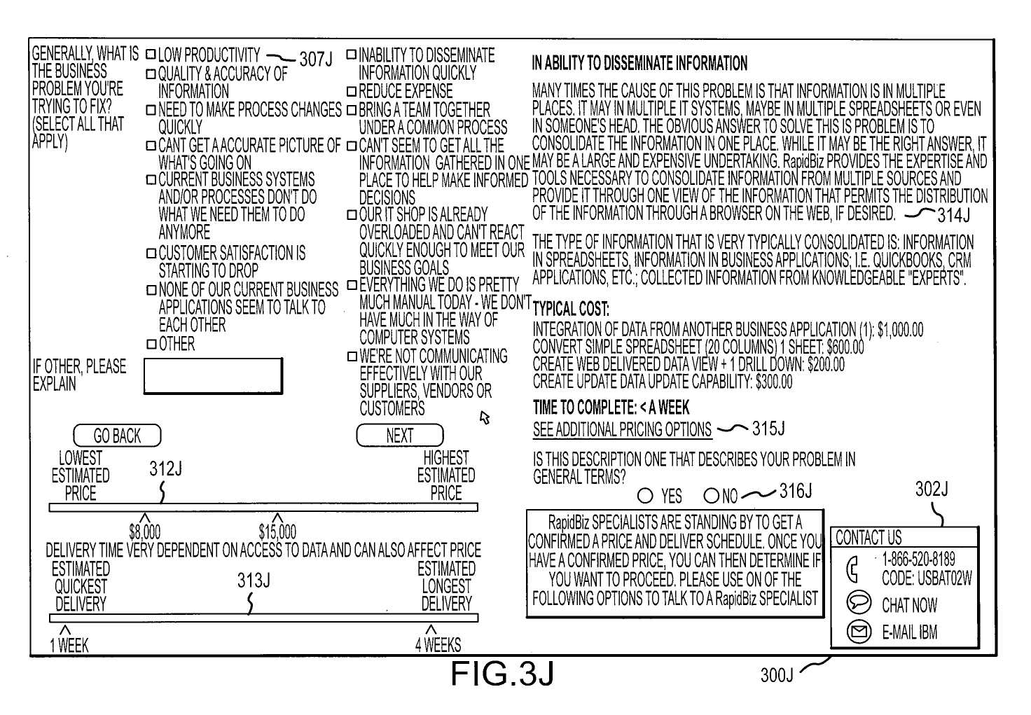

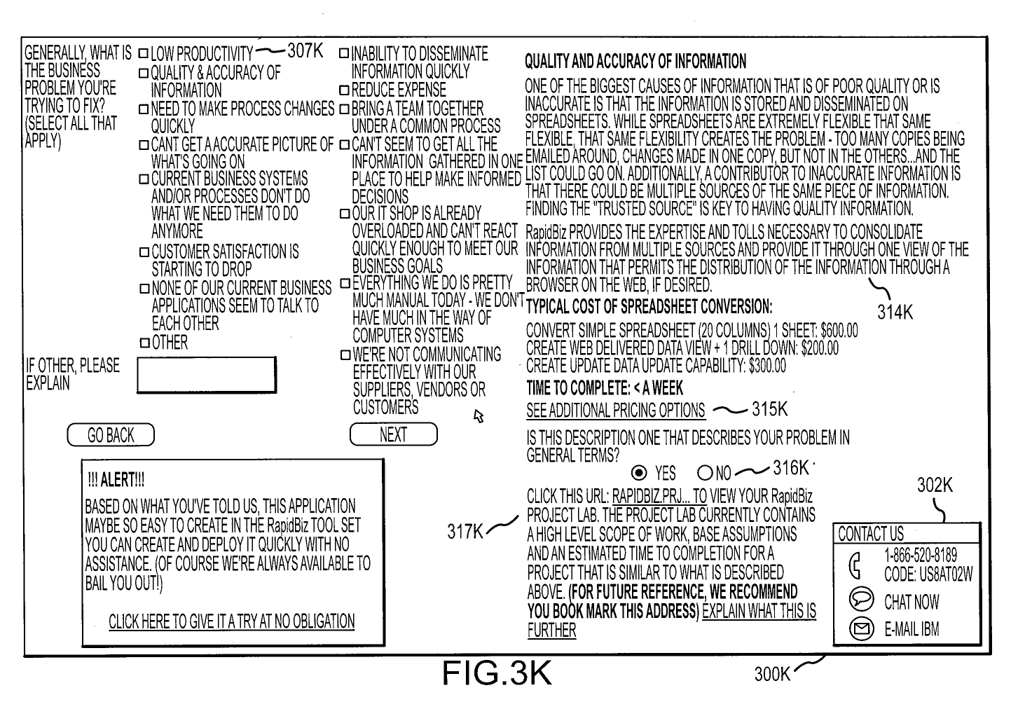

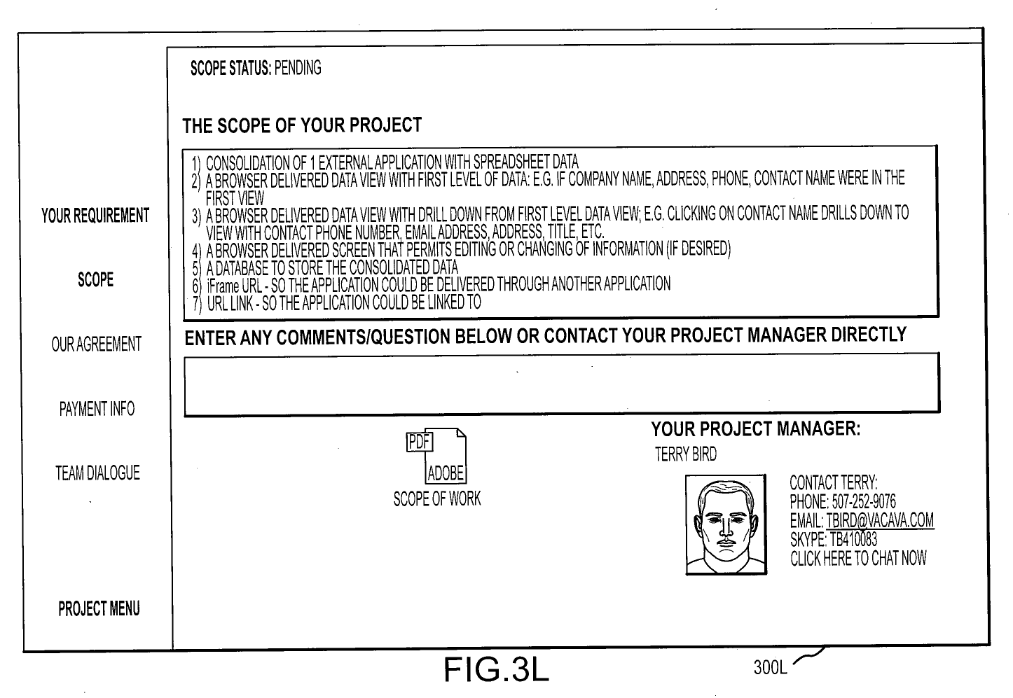

The method of automated diagnostic price and/or time quote determination for application development services that may be performed by the system 100 of FIG. 1 is described in connection with FIG. 2C below, and example user interface screens (e.g., screens viewed by a potential client) that may be displayed on the user computing device 105 in connection with the diagnostic price and/or time quote determination for application development services are illustrated in FIGS. 3A-3L, which are described below.

Accordingly, FIG. 2C is a flow chart illustrating a method 2000 of automated diagnostic price and/or time quote determination for application development services, which may be performed by the system 100 of FIG. 1. In a first operation 2001, the deployment environment computing device 101 may receive a request to provide a price and/or time quote. The requested price and/or time quote may be a price and/or time quote for application development services, such as the development of a business accounts payable software application. The deployment environment computing device 101 may receive the request from the user computing device 105 and the request may have been submitted by a user (e.g., a client desiring application development services) via the browser application.

In a second operation 2002, the deployment environment computing device 101 may transmit an initial set of diagnostic questions to the user computing device 105. The user computing device 105 may display the initial set of diagnostic questions to the user via the browser application. The initial set of diagnostic questions may be presented with a set of possible responses, such as a drop down menu, radio buttons, a multiple choice menu, and so on.

The deployment environment computing device 101 may generate the initial set of diagnostic questions from a knowledge base of information, stored in the tangible storage media 103, concerning factors that influence the cost and/or time required to develop business software applications. For example, one factor that may influence the cost and/or time required to develop business software applications may include the business problem that the business software application is to be developed to solve. Such business problems may include low productivity; problems with quality and accuracy of information; need to make process changes quickly; inability to obtain an accurate picture of what is going on in the business; current business systems and/or processes do no longer do what is needed; customer satisfaction is starting to drop; current business applications do not speak to each other; inability to disseminate information quickly; need to reduce expenses; need to bring a team together under a common process; inability to get information together in one place to make informed decisions; information technology shop is already overloaded and cannot react quickly enough to meet business needs; business processes primarily manual without much in the way of computer systems; ineffective communication with suppliers, vendors, and/or customers; and so on. Based on information stored in the knowledge base, the particular business problem that the user wants a business software application developed to solve provides indications as to the cost and/or time that will be required to develop the business software application.

In some implementations the knowledge base may store the initial set of diagnostic questions, and thus generating the initial set of diagnostic questions may include retrieving the questions from the knowledge base. In other implementations the knowledge base may store statistical information about costs and/or times associated with developing business software applications and generating the initial set of diagnostic questions may include analyzing the statistical information to determine which diagnostic questions to include in the initial set. In such implementations, the deployment environment computing device 101 may receive updates regarding costs and/or times associated with development of business software applications as the business software applications are developed, such as from an accounting system or a project tracking system. In this way, the statistical information may be improved and/or kept current over time.

In a third operation 2003, the deployment environment computing device 101 receives a response to the initial set of diagnostic questions. The deployment environment computing device 101 may receive the response from the user computing device 105 and the response may have been submitted by a user via the browser application. The may have been selected from a set of possible responses, such as a drop down menu, radio buttons, a multiple choice menu, and so on.

In a fourth operation 2004, the deployment environment computing device 101 may generate an initial cost and/or time estimate quote based on weighting pre-assigned to information included in the response. The initial cost and/or time estimate quote may be a range of costs and/or times, such as $5-$100,000, 1 hour to 5 months, and so on. The knowledge base may include weightings pre-assigned to possible responses that the user is allowed to select in response (such as via a drop down menu, radio buttons, a multiple choice menu, and so on) to the initial set of questions, such as weighting a response including a business problem of inability to disseminate information quickly higher than a response including a business problem of inability to obtain an accurate picture of what is going on in the business because the knowledge base includes information indicating that business software applications developed to solve the former business problem require more time and/or cost than business software applications developed to solve the latter. The weightings assigned to possible responses included in the knowledge base may be based on analysis of historical data regarding development of previous business software applications, such as previous business software applications developed to solve the business problem of inability to disseminate information quickly were more complex development projects than business software applications developed to solve the business problem of inability to obtain an accurate picture of what is going on in the business and thus the former is assigned a higher weight than the latter. For example, the business problem of inability to disseminate information quickly may be assigned a total weighting of 1.7 and the business problem of inability to obtain an accurate picture of what is going on in the business may be assigned a total weighting of 1.1. Total weightings are the sum of the weights assigned to each drill down diagnostic question. Thus, the deployment environment computing device 101 may utilize the weighting of 1.7 to generate a higher initial cost and/or time estimate quote when receiving a response that includes the business problem of inability to disseminate information quickly rather than the business problem of inability to obtain an accurate picture of what is going on in the business.

In a fifth operation 2005, the deployment environment computing device 101 may transmit the initial cost and/or time estimate quote to the user computing device 105. The user computing device 105 may display the initial cost and/or time estimate quote to the user (e.g., client) via the browser application. In this way, the user is able to obtain the initial cost and/or time estimate quote quickly with a minimum amount of interaction, maintaining the user's interest.

In a sixth operation 2006, the deployment environment computing device 101 refines the initial cost and/or time estimate quote. The deployment environment computing device 101 may refine the initial cost and/or time estimate quote in response to a request from the user computing device 105, which may be submitted by the user via the browser application. Refining the initial cost and/or time estimate quote includes generating at least one additional set of diagnostic questions from the knowledge base of information, receiving a response from a set of possible responses to the additional sets of diagnostic questions, generating a refined cost and/or time estimate quote based on a weighting pre-associated in the knowledge base with information included in the response, and transmitting the refined cost and/or time estimate quote to the client device. The refined cost and/or time estimate quote may be range of costs and/or times that is narrower than the initial cost and/or time estimate quote or may even be a fixed cost and/or time quote rather than an estimate range. The additional sets of diagnostic questions may include additional factors that influence the cost and/or time required to develop business software applications. The additional sets of diagnostic questions may include additional factors that are more detailed and/or technical that the initial set of diagnostic questions. For example, these additional factors may include the number of users who will use the application; the number and type of information sources (such as the number and/or type of spreadsheets or databases) that would be integrated; whether the business software application or views of the business software application would be delivered to customers, suppliers, and or vendors; and so on.

Refining the initial cost and/or time estimate quote may be an iterative process. For example, the user may submit a request to refine the initial cost and/or time estimate quote and the deployment environment computing device (e.g., server) may generate and transmit the requested refined cost and/or time estimate quote. The user may then submit a request to further refine the initial cost and/or time estimate quote and the deployment environment may generate and transmit the requested further refined cost and/or time estimate quote in any number of repetitions. In some implementations, each iteration of refinement may generate more detailed and/or more technical diagnostic questions and each refined cost and/or time estimate quote that is generated from the more detailed and/or more technical diagnostic questions may be a narrower range of costs and/or times than the previous cost and/or time estimate quote, such as a fixed cost and/or time quote rather than an estimate range. In this way, the user's interest is maintained as they are able to refine based on the amount of additional interaction they are willing to expend. This increases the likelihood that the user will participate long enough to purchase development services.

The method 2000 of FIG. 2C may include additional operations other than those illustrated above. In a first example, the deployment environment computing device 101 may receive an indication from the user computing device 105, submitted by the user via the browser application, indicating a business role of the user. The business role may include roles such as business executive, business manager, IT (information technology) executive, IT manager, technical user, programmer, operations executive, manager of operations, operational user, and so on. The deployment environment computing device 101 may utilize the business role of the user to tailor the diagnostic price and/or time quote determination and/or various information presented to the user via the browser application. In some implementations, the diagnostic questions may be more detailed and/or technical if the business role of the user indicates that the user is more technologically capable, such as a programmer as opposed to a business manager. In other implementations, the deployment environment computing device 101 may transmit information to the user computing device 105 to display in the browser application related to development of business software applications related to that particular business role, such as quotes from other business executive customers if the user's role is a business executive and/or information related to how development of business software applications can be beneficial to a business from an executive standpoint.

In a second example, the deployment environment computing device 101 may transmit additional information to the user computing device 105, which the user computing device 105 displays to the user via the browser application, related to the user's responses to the diagnostic questions. If the user responds that the user has a business problem of inability to disseminate information quickly, the deployment environment computing device 101 may transmit information related to a typical situation of inability to disseminate information quickly and common solutions. The user may then be able to indicate whether this situation is similar to the user's situation. If this situation is different from the user's situation, the user may be able to submit further information as to how their situation differs. By allowing the user to submit such further information, the deployment environment computing device 101 may enable the user to depart from the automated method and interact with the developer when the user desires. Alternatively, the deployment environment computing device 101 may utilize this further information to modify any cost and/or time estimate quote.

In a third example, the deployment environment computing device 101 may receive an indication from the user computing device 105, submitted by the user via the browser application, indicating an industry of the user's business. The industry may include industries such as manufacturing, manufacturing and distribution, financial-broker, insurance, healthcare-hospital, transportation, distribution, retail, financial-bank, packaging, healthcare-clinic, and so on. The deployment environment computing device 101 may utilize the industry of the user's business to tailor the diagnostic price and/or time quote determination and/or various information presented to the user via the browser application. The information in the knowledge base may indicate that business software applications developed for the manufacturing industry require more cost and/or time to develop than business software applications developed for the insurance industry and the deployment environment computing device 101 may tailor the price and/or time quote determination accordingly.

In a fourth example, the deployment environment computing device 101 may transmit contact information to the user computing device 105, which the user computing device 105 displays to the user via the browser application, that the user can utilize to further contact the developer for additional information (such as a more specific price and/or time quote) and/or to purchase development services. The contact information may include data about contacting the developer (such as telephone numbers, email addresses, and so on) and/or display elements the user can select to directly contact the developer (such as links to email the developer, start a chat with the developer, start a voice over Internet protocol call to the developer, and so on). In this way, the deployment environment computing device 101 augments the automated system 100 with the ability to interact with the developer. By allowing the user to interact with the developer, the deployment environment computing device 101 may enable the user to depart from the automated method 2000.

In a fifth example, the deployment environment computing device 101 may be or may be linked to and/or implements a software application development environment (such as the rB™ tool of the RapidBiz™ environment developed by VACAVA® Inc. and described at the web site www dot vacavarapidbiz dot corn, which is herein incorporated by reference in its entirety as it exists as of the filing date of this application).

In a sixth example, the deployment environment computing device 101 may allow the user, via the browser application executing on the client computing device 101, to purchase development services for the initial price and/or time estimate quote and/or refined price and/or time estimate quote. If the deployment environment computing device 101 allows the user to purchase development services for the initial price and/or time estimate quote and/or refined price and/or time estimate quote, the purchase of the development services may be limited according to the user's responses to the diagnostic questions. Thus, if the user responded that the requested business software application would require integration of only a single spreadsheet, the purchased development services may be limited to integration of only a single spreadsheet without modification of the appropriate price and/or time estimate quote. If the deployment environment computing device 101 allows the user to purchase development services, the deployment environment computing device 101 may transmit a contract for the development services to the user computing device 105, which is then presented to the user via the browser application, and the deployment environment computing device 101 may require a response from the user accepting the contract before allowing purchase of the development services. If the user purchases the development services and the deployment environment computing device 101 is linked to and/or implements a software application development environment, the deployment environment computing device 101 may also allow the user, via the browser application executing on the user computing device 105, the option of entering the software application development environment to begin developing the business software application.

Although the method 2000 of FIG. 2C has been described above as optionally including the additional operations discussed in the examples above, it is understood that the method 2000 of FIG. 2C may be performed without these additional optional operations.

FIGS. 3A-3L illustrate example screens 300A-300L that may be displayed by the browser application executing on the user computing device 105 in accordance with an example implementation of the present disclosure. FIG. 3A illustrates a screen 300A where a user is prompted 301A to enter the business role of the user. As illustrated in FIG. 3A, the screen includes contact information for the developer 302A (a telephone number as well as links to initiate a chat session with the developer and/or email the developer.

FIG. 3B illustrates a screen 300B where the user has indicated that their business role is that of a business executive. As illustrated, the screen 300B includes a prompt 303B for the user to enter the industry of the user's business. The screen 300B also includes a quote 304B from another business executive customer and information about the benefits of business software applications from the executive point of view, a link 305B to additional quotes from other business executive customers, and a link 306B to additional information on possible uses for business software applications.

FIG. 3C illustrates a screen 300C where the user has indicated that their business industry is manufacturing, distribution and packaging. As illustrated, the screen 300C includes a prompt 307C for the user to enter the business problem that the user wants the business software application to solve. The screen 300C also includes a common problem 308C in this business industry and a solution to this common problem along with price information for the solution, a link 309C to learn more and try the solution to the common problem, a link 310C to other pricing options for the common problem, and a link 311C to other common problems and solutions.

FIG. 3D illustrates a screen 300D where the user has indicated that their business problem is the inability to disseminate information. As illustrated, the screen 300D includes a cost estimate range 312D of $3700 to $50,000 and a time estimate range 313D of 1 week to 4 weeks. The screen 300D also includes information 314D on common problems related to inability to disseminate information and the solutions to those common problems as well as a link 315D to additional pricing options. The screen 300D further includes a set of radio buttons 316D prompting the user to indicate whether the information on common problems describes the user's business problem in general terms.

FIG. 3E illustrates a screen 300E where the user has selected the “yes” button on the screen 300D of FIG. 3D. As illustrated, the screen 300E now includes information and a link 317E to a Project Lab that is customized for the user's business problem based on the common problems and corresponding solutions as well as a link to further information about the Project Lab.

FIG. 3F illustrates a screen 300F where the user has selected the “no” button on the screen of FIG. 3D. As illustrated, the screen 300F includes information 318F from the screen in FIG. 3D on common problems related to inability to disseminate information as well as a prompt 319F for the user to enter how their situation is different from the common problems.

FIG. 3G illustrates a screen 300G where the user has clicked the next button on the screen 300D illustrated in FIG. 3D, indicating they wish to refine the cost and time estimates. As illustrated, the screen 300G includes prompts 320G for the user to enter more specific information about the software business application they want developed including the number of users for the business software application; the number of spreadsheets and/or other databases that would be integrated; and whether the application and/or views of the application would be delivered to customers, suppliers, and so on. FIG. 3H illustrates the screen 300H of FIG. 3G after the user has entered the answers to the prompted additional questions illustrated in FIG. 3G. As illustrated, the cost estimate range 312H has been refined to narrow the cost range to $5500 to $15,000. The screen 300H also now includes a link 321H that the user can click to further refine the cost and/or time estimate by providing even more detailed and/or technical information.

FIG. 3I illustrates a screen 300I where the user has clicked the link 321H on the screen 300H of FIG. 3H to further refine the cost and/or time estimate by providing even more detailed and/or technical information. As illustrated, the screen 300I includes prompts 320I for the user to enter even more specific information about the software business application they want developed, including the particular types of databases where the information is stored (such as SQL, Oracle, IBM DB2, and Informix), in order to further refine the cost and/or time estimate.

FIG. 3J illustrates the screen 300J of FIG. 3I after the user has entered the answers to the prompted additional questions. As illustrated, the cost estimate range 312J has been refined to narrow the cost range to $8000 to $15,000.

FIG. 3K illustrates a screen 300K where the user's problem has been identified as one that the user may be capable of utilizing the RapidBiz tool set to develop the business software application on their own. As illustrated, the screen 300K includes an alert to that effect and a link for the user to try utilizing the RapidBiz tool set to develop the business software application on their own. FIG. 3L illustrates a screen 300L where the user clicked the link on the screen of FIG. 3K to try utilizing the RapidBiz tool set.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for automated diagnostic determination of at least one of a price quote and a time quote, comprising:
at least one tangible storage media, operable to store at least one set of instructions; and
at least one processing unit that executes the at least one set of instructions stored in the at least one non-transitory storage media to:
receive a request to provide at least one of a price quote and a time quote,
transmit an initial set of diagnostic questions,
receive at least one response to the initial set of diagnostic questions,
generate an initial estimate quote based on a weighting assigned to the at least one response to the initial set of diagnostic questions wherein the weighting is retrieved from at least one knowledge base stored in the at least one non-transitory storage medium,
transmit the initial estimate quote, and
refine the initial estimate quote in response to receiving a request to refine by transmitting at least one additional diagnostic question and modifying the initial estimate quote based on an additional weighting assigned to at least one additional response to the at least one additional diagnostic question.

2. The system of claim 1, wherein the weighting and the additional weighting are based on at least one of statistical time information and statistical cost information stored in the at least one knowledge base about completed application development services.

3. The system of claim 1, wherein the at least one processing unit receives an acceptance of the refined initial quote and updates the at least one knowledge base with at least one of time information and cost information about performance of at least one transaction corresponding to the acceptance.

4. The system of claim 1, wherein the initial estimate quote comprises a first range, the refined initial estimate comprises a second range, and the second range is narrower than the first range.

5. The system of claim 1, wherein the at least one processing unit further refines the refining initial estimate quote in response to receiving a request to further refine by transmitting at least one second additional diagnostic question and modifying the refined initial estimate quote based on a second additional weighting assigned to at least one second additional response to the at least one second additional diagnostic question.

6. The system of claim 1, wherein the at least one processing unit retrieves at least one of the initial set of diagnostic questions and at least one additional diagnostic question from the at least one knowledge base.

7. The system of claim 1, wherein the at least one processing unit selects the at least one additional diagnostic question based on the at least one response to the initial set of diagnostic questions.

8. The system of claim 1, wherein the at least one processing unit and the at least one tangible storage media are components of at least one server computing device that receives the request to provide the at least one of the price quote and the time quote via at least one browser software application executes by at least one client computing device.

9. A method for automated diagnostic determination of at least one of a price quote and a time quote, comprising:
receiving a request to provide at least one of a price quote and a time quote utilizing at least one processing unit;
transmitting an initial set of diagnostic questions utilizing the at least one processing unit;
receiving at least one response to the initial set of diagnostic questions utilizing the at least one processing unit;
generating an initial estimate quote, utilizing the at least one processing unit, based on a weighting assigned to the at least one response to the initial set of diagnostic questions wherein the weighting is retrieved from at least one knowledge base stored in at least one non-transitory storage medium;
transmitting the initial estimate quote utilizing the at least one processing unit; and
refining the initial estimate quote in response to receiving a request to refine, utilizing the at least one processing unit, by transmitting at least one additional diagnostic question and modifying the initial estimate quote based on an additional weighting assigned to at least one additional response to the at least one additional diagnostic question.

10. The method of claim 9, wherein the request to provide the at least one of the price quote and the time quote comprises at least one of a price quote for application development services and a time quote for application development services.

11. The method of claim 9, wherein the weighting and the additional weighting are based on at least one of statistical time information and statistical cost information stored in the at least one knowledge base about completed application development services.

12. The method of claim 9, further comprising:
receiving an acceptance of the refined initial quote; and
updating the at least one knowledge base with at least one of time information and cost information about performance of at least one transaction corresponding to the acceptance.

13. The method of claim 9, wherein the initial estimate quote comprises a first range, the refined initial estimate comprises a second range, and the second range is narrower than the first range.

14. The method of claim 9, wherein the at least one additional response to the at least one additional diagnostic question includes information that is at least one of more technical and more detailed than the at least one response to the initial set of diagnostic questions.

15. The method of claim 9, further comprising further refining the refining initial estimate quote in response to receiving a request to further refine by transmitting at least one second additional diagnostic question and modifying the refined initial estimate quote based on a second additional weighting assigned to at least one second additional response to the at least one second additional diagnostic question.

16. The method of claim 9, wherein said operation of transmitting an initial set of diagnostic questions utilizing the at least one processing unit further comprises retrieving the initial set of diagnostic questions from the at least one knowledge base.

17. The method of claim 9, wherein the at least one additional diagnostic question is retrieved from the at least one knowledge base.

18. The method of claim 9, wherein the at least one additional diagnostic question is selected based on the at least one response to the initial set of diagnostic questions.

19. The method of claim 9, wherein the an initial set of diagnostic questions are selected based on received information regarding a role of a user that submitted the request to provide the at least one of the price quote and the time quote.

20. A computer program product, comprising:
a first set of instructions, stored in at least one non-transitory computer readable medium executable by at least one processing unit to receive a request to provide at least one of a price quote and a time quote;
a second set of instructions, stored in the at least one non-transitory computer readable medium executable by the at least one processing unit to transmit an initial set of diagnostic questions retrieved from at least one knowledge based stored in the at least one non-transitory computer readable medium;
a third set of instructions, stored in the at least one non-transitory computer readable medium executable by the at least one processing unit to receive at least one response to the initial set of diagnostic questions;
a fourth set of instructions, stored in the at least one non-transitory computer readable medium executable by the at least one processing unit to generate an initial estimate quote based on a weighting assigned to the at least one response;
a fifth set of instructions, stored in the at least one non-transitory computer readable medium executable by the at least one processing unit to transmit the initial estimate quote; and
a sixth set of instructions, stored in the at least one non-transitory computer readable medium executable by the at least one processing unit to refine the initial estimate quote.
